(19) United States
(12) Patent Application Publication
(10) Pub. No.: US 2017/0075840 A1
(43) Pub. Date: Mar. 16, 2017

(54) INFORMATION PROCESSING APPARATUS AND METHOD FOR GUIDING CONNECTION DESTINATION

(71) Applicant: TOSHIBA TEC KABUSHIKI KAISHA, Tokyo (JP)

(72) Inventor: Hirokazu Matsuno, Mishima (JP)

(21) Appl. No.: 15/180,179

(22) Filed: Jun. 13, 2016

(30) Foreign Application Priority Data
Sep. 15, 2015 (JP) 2015-182095

(51) Int. Cl. G06F 13/38; G06F 13/10

(52) U.S. Cl. CPC G06F 13/387; G06F 13/102; H04W 84/12

(57) ABSTRACT

An information processing apparatus comprises a management module configured to manage peripheral device information relating to a peripheral device connected with connection destination devices in association with each of the connection destination devices, a selection module configured to select a connection destination candidate from the connection destination devices on the basis of the peripheral device information if connection is requested from a new peripheral device and an informing module configured to inform the connection destination device serving as the connection destination candidate selected by the selection module.

### CROSS-REFERENCE TO RELATED APPLICATION

This application is based upon and claims the benefit of priority from Japanese Patent Application No. 2015-182095, filed Sep. 15, 2015, the entire contents of which are incorporated herein by reference.

### FIELD

Embodiments described herein relate generally to an information processing apparatus and a method for guiding a connection destination.

### BACKGROUND

Conventionally, in an information processing apparatus such as a POS terminal, a function is added by connecting the information processing apparatus with a peripheral device such as a printer. Further, in recent years, with the use of a wireless communication technology such as a wireless LAN or a Bluetooth® Technology, a peripheral device connectable in a cableless manner is introduced.

Incidentally, in a case of carrying out wireless connection, for example, based on radio wave intensity, it is possible that a user randomly selects a connection destination.

### DESCRIPTION OF THE DRAWINGS

FIG. 1 is a diagram illustrating an example of the structure of a store system according to a first embodiment;

FIG. 2 is a block diagram illustrating an example of the structure of a POS terminal according to the first embodiment;

FIG. 3 is a diagram illustrating an example of an information management table;

FIG. 4 is a diagram illustrating another example of an information management table;

FIG. 5 is a diagram illustrating an example of an informing screen;

FIG. 6 is a diagram illustrating another example of an informing screen;

FIG. 7 is a diagram illustrating another example of an informing screen;

FIG. 8 is a diagram illustrating an example of a network configuration diagram;

FIG. 9 is a flowchart illustrating an example of a connection destination guide processing executed by the POS terminal according to the first embodiment;

FIG. 10 is a diagram illustrating an example of the structure of a store system according to a second embodiment;

FIG. 11 is a block diagram illustrating an example of the structure of a POS terminal according to the second embodiment;

FIG. 12 is a block diagram illustrating an example of the structure of a server device according to the second embodiment; and

FIG. 13 is a flowchart illustrating an example of a connection destination guide processing executed through the cooperation of the POS terminal and the server device according to the second embodiment.

### DETAILED DESCRIPTION

There is a case in which a plurality of peripheral devices is concentratedly connected with a specific information processing apparatus. In this case, a load of the specific information processing apparatus is larger than loads of other information processing apparatuses, and it is possible that a phenomenon that plural peripheral devices with the same function are connected with the same information processing apparatus occurs. Thus, in a case in which there is a plurality of connection destinations of a peripheral device, a technology capable of guiding the connection destination is desired.

In accordance with an embodiment, an information processing apparatus comprises a management module, a selection module, and an informing module. The management module manages peripheral device information relating to a peripheral device connected with connection destination devices in association with each of the connection destination devices. The selection module selects a connection destination candidate from the available connection destination devices on the basis of the peripheral device information if connection is requested from a new peripheral device. The informing module informs the connection destination device serving as the connection destination candidate selected by the selection module.

Hereinafter, an embodiment concerning the information processing apparatus and a method for guiding a connection destination are described in detail with reference to the accompanying drawings. The embodiment described below is only one embodiment about the information processing apparatus and the method guiding a connection destination, and does not limit the structure and specification thereof. The present embodiment is an application example to a store system arranged in a store such as a supermarket.

### First Embodiment

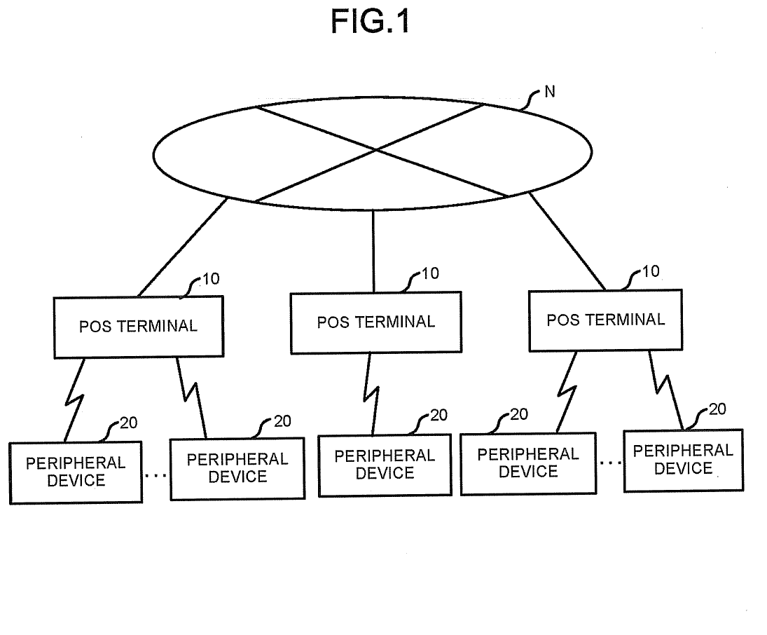

FIG. 1 is a diagram illustrating an example of the structure of a store system according to the first embodiment. As shown in FIG. 1, the store system comprises POS terminals 10 and peripheral devices 20.

The POS terminal 10 which is an information processing apparatus according to the present embodiment can execute a commodity sales data processing relating to registration and settlement of commodities. The POS terminal 10, connected with a network N such as an LAN (Local Area Network), transmits and receives various kinds of information to and from other POS terminals 10. Further, the POS terminal 10 may be, for example, a stationary terminal arranged in a checkout area in a store or a portable terminal such as a tablet terminal or other handheld device.

The peripheral devices 20 which can include a keyboard, a display device, a code scanner, and/or a printer and the like operate along with the POS terminals 10. The peripheral devices 20 wirelessly connect with the POS terminals 10 serving as connection destination devices.

In the present embodiment, the peripheral devices 20 are generally divided into existing peripheral devices 20 for which connection (communication) with the POS terminals 10 is established and new peripheral devices 20 for which no connection (communication) with the POS terminals 10 is established. A new peripheral device 20 becomes an existing peripheral device 20 by establishing the cableless connection with a POS terminal 10 after sending a connection request to the POS terminal 10 serving as a connection target. The types (device type or product type) of the peripheral device 20 are contained in the connection request.

Further, no specific limitations are given to a connection method of the POS terminal 10 and the peripheral device 20. For example, the peripheral device 20 may be connected with the POS terminal 10 with the use of a wireless communication standard such as Bluetooth® Technology, Zigbee® Technology, or the IEEE family of protocols 802.11(a), 802.11(b), 802.11(g), 802.11(n), 802.11(ac), 802.11(ad), etc. Furthermore, the peripheral device 20 may be connected with the POS terminal 10 via the network N through a wireless access point (not shown) connected with the network N.

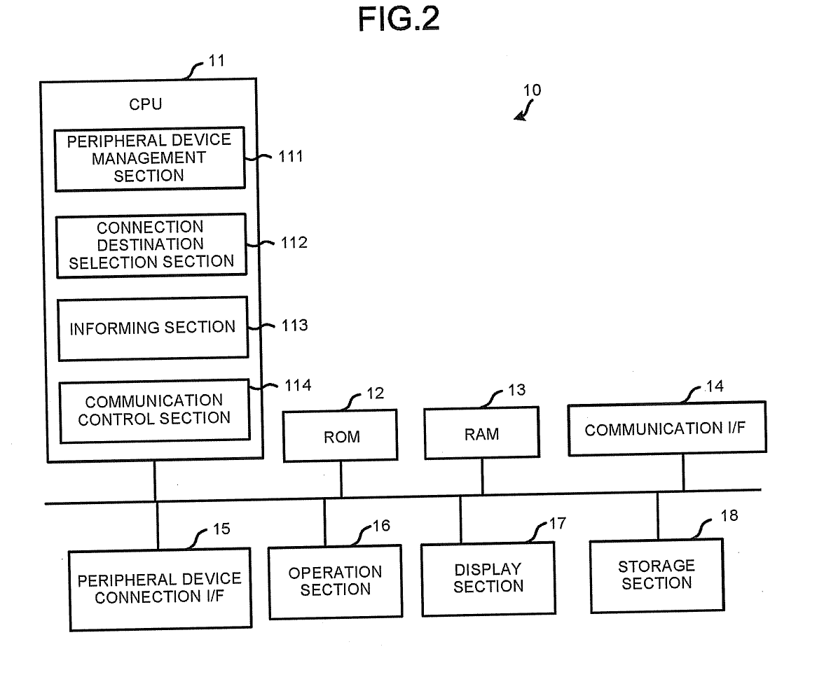

FIG. 2 is a block diagram illustrating an example of the structure of the POS terminal 10. As shown in FIG. 2, the POS terminal 10 includes a CPU (Central Processing Unit) 11, a ROM (Read Only Memory) 12, a RAM (Random Access Memory) 13, a communication I/F 14, a peripheral device connection I/F 15, an operation section 16, a display section 17 and a storage section 18. Further, the POS terminal 10 includes a timing device (not shown) such as a RTC (Real Time Clock) and the like.

The ROM 12 stores various programs executed by the CPU 11 and various kinds of data. The RAM 13 temporarily stores data and programs when the CPU 11 executes various programs. The CPU 11 enables each function section described later to be realized through copying or decompressing various programs stored in the ROM 12 or the storage section 18 on the RAM 13 to execute them.

The communication I/F 14 is, for example, an LAN interface for wired or wireless communication. The POS terminal 10 transmits and receives various kinds of information to and from other POS terminals 10 connected with the network N through the communication I/F 14.

The peripheral device connection I/F 15 is connected with the peripheral device 20 through wireless communication and is a communication interface such as Bluetooth® Technology. The POS terminal 10 cooperates with the peripheral device 20 connected with the peripheral device connection I/F 15. Further, in a case in which the peripheral device 20 is connected with the POS terminal 10 via the network N, the communication I/F 14 functions as the peripheral device connection I/F 15.

The operation section 16 is an input device such as a keyboard, a pointing device and the like. The operation section 16, if receiving an operation, outputs the operation content to the CPU 11. The display section 17 is a display device such as an LCD (Liquid Crystal Display) and the like. The display section 17 displays various kinds of information under the control of the CPU 11. Further, the display section 17 may be the structure of a touch panel. In this case, the touch panel functions as the operation section 16.

The storage section 18 is a storage device equipped with a non-volatile storage medium such as an HDD (Hard Disk Drive), an SSD (Solid State Drive) and the like. The storage section 18 stores various programs and various kinds of data relating to operations of the POS terminal 10. For example, the storage section 18 stores a commodity master file in which commodity information relating to each commodity is registered in association with a commodity ID for identifying the commodity. The related commodity information, for example, contains a commodity name, a unit price and the like of a corresponding commodity. Furthermore, the storage section 18 stores an information management table described later.

In the present embodiment, each of the POS terminals 10 holds a commodity master file; however, the present invention is not limited to this. For example, it is possible that an external device (not shown) such as a store server connected with the network N holds a commodity master file and the POS terminal 10 refers to the commodity master file.

The CPU 11 of the POS terminal 10 includes a peripheral device management section 111, a connection destination selection section 112, an informing section 113 and a communication control section 114 as function sections through the execution of the programs stored in the ROM 12 or the storage section 18.

The peripheral device management section 111 acquires information (such as peripheral device information) relating to the existing peripheral device 20 connected with the POS terminal 10 (self-terminal). For example, the peripheral device management section 111 acquires the number and type of the peripheral devices 20 connected with the peripheral device connection I/F 15 of the self-terminal as the peripheral device information. Herein, the type of the peripheral device 20 includes, for example, a device type such as a code scanner, a printer, and the like and a product type such as a model name, a product code, and the like.

Further, the peripheral device management section 111 acquires peripheral device information from other POS terminals 10 through the communication I/F 14. The peripheral device management section 111 supplies the peripheral device information acquired by the self-terminal to other POS terminals 10. Then, the peripheral device management section 111 mutually transmits and receives the peripheral device information to and from the POS terminals 10 to acquire the peripheral device information of all the POS terminals 10 connected with the network N.

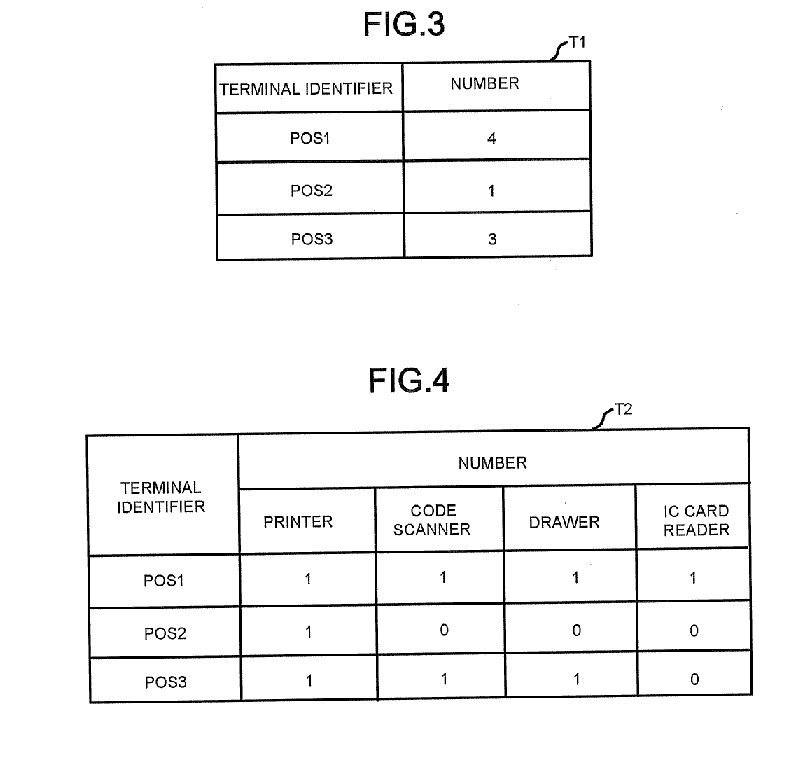

The peripheral device management section 111 stores the peripheral device information acquired from each POS terminal 10 (containing the self-terminal) in the information management table to manage the acquired peripheral device information. Hereinafter, with reference to FIG. 3 and FIG. 4, the information management table is described.

FIG. 3 is a diagram illustrating an example of the information management table. The information management table T1 shown in FIG. 3 indicates an example of a table structure in a case in which the number of the peripheral devices 20 is acquired as the peripheral device information. As shown in FIG. 3, the information management table T1 stores a terminal identifier of each POS terminal 10 and the number of the peripheral devices 20 connected to the POS terminal 10 associated with each other. Herein, “terminal identifier” is identification information for identifying each of POS terminals 10. The terminal identifier refers to, for example, an IP address or a host name assigned to each of the POS terminals 10. Further, “number” refers to the number of the existing peripheral devices 20 connected with the POS terminal 10 identified by the terminal identifier.

FIG. 4 is a diagram illustrating another example of the information management table. An information management table T2 shown in FIG. 4 indicates an example of a table structure in a case in which the number and the type (device type) of the peripheral devices 20 are acquired as the peripheral device information. As shown in FIG. 4, the information management table T2 stores the terminal identifier of each POS terminal 10 and the number of the peripheral devices 20 of each device type connected with the POS terminal 10 associated with each other. In the information management table T2, “printer”, “code scanner”, “drawer” and “IC card reader” are listed as the device types, and the number of the connected peripheral devices 20 is stored by each device type.

If acquiring the peripheral device information from a POS terminal 10, the peripheral device management section 111 stores the peripheral device information in the information management table in association with the terminal identifier of the POS terminal 10. If it is detected that a new POS terminal 10 is connected with the network N, the peripheral device management section 111 registers the terminal identifier of the POS terminal 10 in the information management table. Further, if it is detected that an existing POS terminal 10 is removed from the network N, the peripheral device management section 111 deletes the terminal identifier of the POS terminal 10 from the information management table.

Further, no specific limitations are given to timing when the peripheral device management section 111 acquires (transmits and receives) the peripheral device information. For example, the peripheral device management section 111 may receive or transmit the peripheral device information at the time of the activation of the self-terminal. Further, the peripheral device management section 111 may receive or transmit the peripheral device information in a case of receiving the connection request from the new peripheral device 20 or in a case of establishing the connection with the new peripheral device 20.

Further, no specific limitations are given to the acquisition (transmission and receiving) method of the peripheral device information either. For example, the peripheral device management section 111 may send an acquisition request to other POS terminals 10 to actively acquire the peripheral device information. Further, the peripheral device management section 111 may passively acquire the peripheral device information provided from other POS terminals 10.

The connection destination selection section 112 selects a POS terminal 10 serving as a connection destination candidate of a peripheral device 20 with the use of the information management table. For example, if receiving the connection request from a new peripheral device 20, the connection destination selection section 112 selects the connection destination candidate of the peripheral device 20 from the POS terminals 10 (terminal identifiers) registered in the information management table.

The selection of the connection destination candidate is carried out according to a predetermined selection condition. The selection condition refers to setting information for determining a condition or an index and a method at the time of the selection of the POS terminal 10 of the connection destination, which is stored in the storage section 18. It is possible that the content of the selection condition is not limited specifically and is set optionally.

For example, as the selection condition, the condition under which the POS terminal 10 with which the minimum number of the peripheral devices 20 is connected is regarded as the connection destination candidate may be set. In this case, the connection destination selection section 112 selects the POS terminal 10 with which the minimum number of the peripheral devices 20 is connected from the POS terminals 10 (terminal identifiers) registered in the information management table.

Further, a selection method in a case in which the plural POS terminals 10 exist may be set as the selection condition. In this case, for example, the selection method may be set to select one POS terminal 10 according to the predetermined priority. Alternatively, the selection method may be set to select all the plural POS terminals 10 or a subset thereof.

Further, the configuration (recommended configuration) of the device type of the peripheral device 20 may be set as the selection condition. It can be set that the recommended configuration, for example, includes one printer, one code scanner and one drawer respectively. In this case, the connection destination selection section 112 determines the device type of the new peripheral device 20 according to the information contained in the connection request. Next, the connection destination selection section 112 determines whether or not the determined device type corresponds to the device type set through the recommended configuration. In a case in which the determined device type corresponds to the device type set through the recommended configuration, the connection destination selection section 112 selects the POS terminal 10, with which the determined device types the number of which does not meet the number of the device types set through the recommended configuration are connected, from the POS terminals 10 (terminal identifiers) registered in the information management table.

A selection method in a case in which the determined device type does not correspond to the device type set through the recommended configuration, or in a case in which all the POS terminals 10 meet the recommended configuration may be set as the selection condition. In this case, for example, the selection method may be set to select one POS terminal 10 according to predetermined priority. Further, the selection method may be set to select one POS terminal 10 with which the minimum number of the peripheral devices 20 is connected. Further, the selection method may be set to select the POS terminal 10 receiving the connection request as the self-terminal. Further, the selection method may be set to select the POS terminal 10 with the strongest signal or the closest proximity.

Further, the selection of the connection destination candidate is not limited to the new peripheral device 20, and may be carried out for the existing peripheral device 20. Specifically, the connection destination selection section 112 may select the connection destination candidate of the existing peripheral device 20 connected with the self-terminal according to the selection condition. For example, a case is assumed in which a condition under which the POS terminal 10 the number of the existing peripheral devices 20 connected with which is equal to or smaller than a predetermined value is regarded as the connection destination candidate is set as the selection condition. In this case, if it is determined that the number of the existing peripheral devices 20 connected with another POS terminal 10 is equal to or smaller than the predetermined value, the connection destination selection section 112 selects another POS terminal 10 as the connection destination candidate of the existing peripheral device 20 connected with the self-terminal. Further, a case is assumed in which the recommended configuration is set as the selection condition. In this case, if it is determined that the configuration of the peripheral devices 20 connected with the self-terminal conforms with the recommended configuration and furthermore the remaining peripheral devices 20 exist, the connection destination selection section 112 selects another POS terminal 10 the number of the peripheral devices 20 connected with which is not enough as the connection destination of the remaining peripheral devices 20.

In this way, for example, in a case in which a new POS terminal 10 not connected with the peripheral device 20 is connected with the network N, a guide processing can be executed to switch the connection destination of the peripheral device 20 connected with the self-terminal to the new POS terminal 10.

Further, no specific limitations are given to timing when the connection destination candidate of the existing peripheral device 20 is selected. For example, the connection destination selection section 112 may select the connection destination candidate at each predetermined period. Further, the connection destination selection section 112 may select the connection destination candidate at the timing when a new POS terminal 10 is connected.

The informing section 113 informs a selection result of the connection destination selection section 112. For example, in a case in which the informing section 113 selects the self-terminal as the connection destination candidate of the new peripheral device 20, the connection destination selection section 112 displays an informing screen for urging the establishment of the connection on the display section 17.

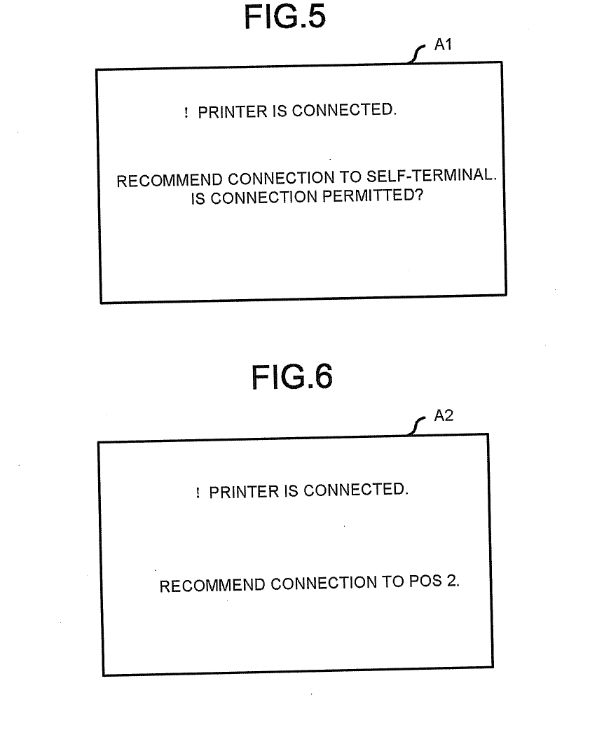

FIG. 5 is a diagram illustrating an example of the informing screen. Herein, FIG. 5 indicates an informing screen A1 in a case in which the connection destination selection section 112 selects the self-terminal as the connection destination candidate, of the new peripheral device 20. As shown in FIG. 5, the informing section 113 indicates the device type (printer) of the new peripheral device 20 that requests the connection with the self-terminal and displays a message for prompting or urging the establishment (permitting) of the connection on the informing screen A1.

Further, for example, the informing section 113 displays an informing screen for prompting or urging the connection with another POS terminal 10 in a case in which the connection destination selection section 112 selects another POS terminal 10 as the connection destination candidate of the new peripheral device 20.

FIG. 6 is a diagram illustrating another example of the informing screen. Herein, FIG. 6 indicates an informing screen A2 in a case in which the connection destination selection section 112 selects another POS terminal 10 (POS 2) as the connection destination candidate of the new peripheral device 20. As shown in FIG. 6, the informing section 113 indicates the device type (printer) of the peripheral device 20 that requests the connection with the self-terminal and displays a message for prompting or urging the connection with the POS 2 on the informing screen A2.

Further, for example, the informing section 113 displays an informing screen for prompting or urging the connection with another POS terminal 10 on the display section 17 in a case in which the connection destination selection section 112 selects another POS terminal 10 as the connection destination candidate of the existing peripheral device 20.

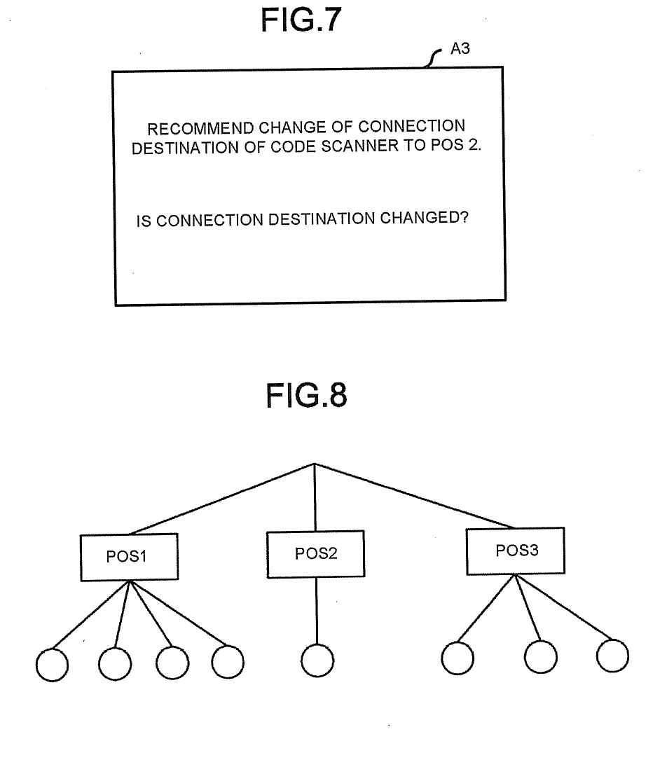

FIG. 7 is a diagram illustrating another example of the informing screen. Herein, FIG. 7 indicates an informing screen A3 in a case in which the connection destination selection section 112 selects another POS terminal 10 (POS 2) as the connection destination candidate of the existing peripheral device 20. As shown in FIG. 7, the informing section 113 indicates the device type (code scanner) of the existing peripheral device 20 serving as a target and displays a message for prompting or urging the change of the connection destination to the POS 2 on the informing screen A3.

A user who operates the new peripheral device 20 or the existing peripheral device 20 confirms the informing screen displayed on the display section 17 of the POS terminal 10. Then, the user carries out an operation of establishing the connection or an operation of switching the connection destination according to the informing screen. In this way, the connection between the POS terminal 10 and the peripheral device 20 is established.

Further, the informing destination of the informing section 113 is not limited to the self-terminal. For example, in a case in which the connection destination selection section 112 selects another POS terminal 10 as the connection destination candidate, the informing section 113 may send informing information for prompting or urging the receiving of the connection to another POS terminal 10. In this case, in the POS terminal 10 receiving the informing information, the informing section 113 displays the informing screen for prompting or urging to receive the connection with the new peripheral device 20 on the display section 17 according to the informing information. Further, the informing section 113 may send informing information for prompting or prompting or urging connection or disconnection and the switching of the connection destination to the new peripheral device 20 that requests the connection. In this way, in the peripheral device 20 receiving the informing information, the display section such as the LCD or an indicator is used to inform the content indicated by the informing information.

The communication control section 114 controls communication between another POS terminal 10 and the peripheral device 20 through the cooperation of the communication I/F 14 and the peripheral device connection I/F 15. For example, in a case in which the connection establishment with a new peripheral device 20 is instructed, the communication control section 114 establishes the connection with the peripheral device 20. Contrarily, in a case in which disconnection with the existing peripheral device 20 is instructed, the communication control section 114 terminates the connection with the peripheral device 20.

Further, the communication control section 114 displays a network configuration diagram indicating the connection relationship of the POS terminal 10 and the peripheral device 20 on the display section 17 in response to a predetermined operation through the operation section 16.

FIG. 8 is a diagram illustrating an example of the network configuration diagram. In FIG. 8, POS 1˜POS 3 correspond to POS terminals 10 shown in FIG. 1. Further, nodes (leaf nodes) connected with POS1˜POS3 correspond to the peripheral devices 20. The communication control section 114 specifies the connection relationship between the POS terminal 10 and the peripheral device 20 according to the peripheral device information. Further, in a case in which a node is selected, the communication control section 114 may control to display the type of the peripheral device 20 corresponding to the node.

In this way, through displaying the connection relationship between the POS terminal 10 and the peripheral device 20 as the network configuration diagram on the display section 17, the connection destination and the connection state can be confirmed easily. In this way, the convenience at the time of confirming the connection destination and the connection state can be improved.

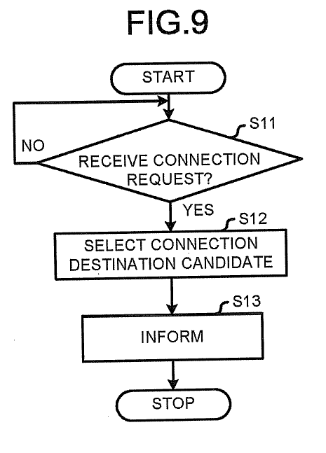

Next, the operations of the POS terminal 10 are described. FIG. 9 is a flowchart illustrating an example of a connection destination guide processing executed by the POS terminal 10. The peripheral device information (information management table) is already acquired as a precondition of the present processing.

First, the connection destination selection section 112 waits for until the connection request is received from the new peripheral device 20 (No in Act S11). If the connection request is received from the new peripheral device 20 (Yes in Act S11), the connection destination selection section 112 selects the POS terminal 10 serving as the connection destination candidate of the peripheral device 20 on the basis of the information management table and the preset selection condition (Act S12).

Sequentially, the informing section 113 carries out the informing operation in response to the selection result in the processing in Act S12 as shown in FIG. 5˜FIG. 7 (Act S13), and terminates the present processing.

As stated above, according to the POS terminal 10 of the present embodiment, if the new peripheral device 20 requests the connection, the POS terminal 10 serving as the connection destination candidate is selected according to the predetermined selection condition and the selection result is informed. In this way, in a case in which plural connection destinations (POS terminals 10) of the peripheral device 20 exist, the connection destinations of the peripheral device 20 can be guided to the user. Thus, it can be prevented that a plurality of peripheral devices 20 is concentratedly connected with the specific POS terminal 10. Further, the standardization of the number and the functions of the peripheral devices 20 connected with each POS terminal 10 can be realized.

In the foregoing embodiment, the connection to the connection destination candidate selected by the connection destination selection section 112 is carried out through a manual operation of the user; however, the present invention is not limited to this. The communication control section 114 may control to carry out an automatic connection. In the case of adopting the structure, the communication control section 114 performs such a control that the new peripheral device 20 is connected with the POS terminal 10 serving as the connection destination candidate selected by the connection destination selection section 112.

Herein, the target controlled by the communication control section 114 is not limited to the peripheral device 20, and may be the POS terminal 10 (containing the self-terminal) serving as the connection destination candidate. For example, in a case in which the connection destination selection section 112 selects another POS terminal 10 other than the self-terminal, the communication control section 114 controls the peripheral device 20 in such a manner that the connection destination of the peripheral device 20 is switched to another POS terminal 10 selected. Further, the communication control section 114 cooperates with the communication control section 114 of another POS terminal 10 selected to control to receive the connection request of the new peripheral device 20. In this way, it is possible for the communication control section 114 to make the peripheral device 20 connected or to switch the connection destination.

Further, in response to the instruction through the network configuration diagram, the communication control section 114 may automatically switch the connection destination. For example, in a case in which an operation is performed to connect one node (peripheral device 20) connected with some POS terminal 10 with another POS terminal 10, the communication control section 114 may control to switch the connection destination of the peripheral device 20 in response to the content of the operation.

### Second Embodiment

In the first embodiment, it is described that each of the POS terminals 10 includes the function of managing the connection destination of the peripheral device 20. In the second embodiment, it is described that one device collectively manages each POS terminal 10 and peripheral devices 20. The same configuration elements as the first embodiment are applied with the same reference numerals, and the description thereof is omitted.

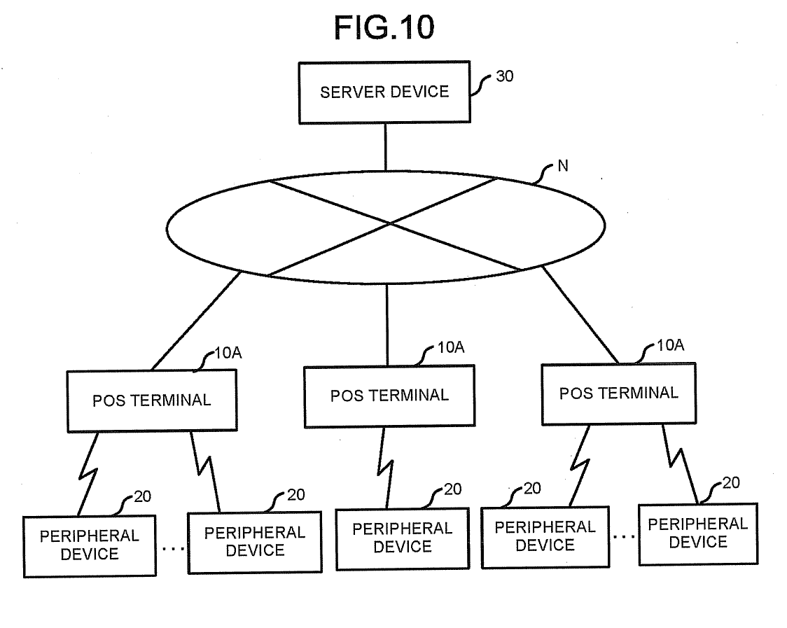

FIG. 10 is a diagram illustrating an example of the structure of a store system according to the second embodiment. As shown in FIG. 10, the store system includes POS terminals 10A, the peripheral devices 20 and a server device 30. Herein, the server device 30 and the POS terminal 10A are connected through the network N.

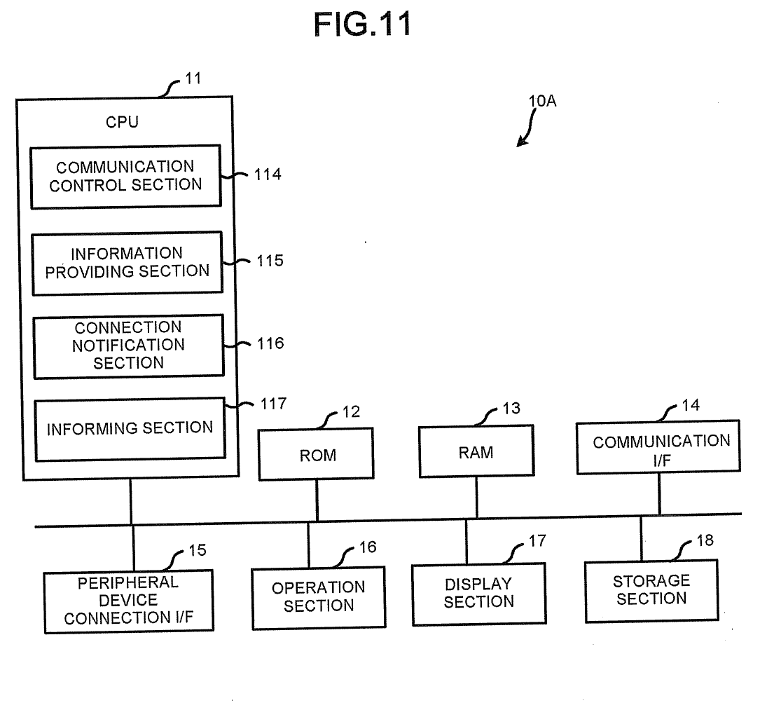

The POS terminal 10A carries out the commodity sales data processing relating to registration and settlement of commodities similarly to the POS terminal 10. FIG. 11 is a block diagram illustrating an example of the structure of the POS terminal 10A. As shown in FIG. 11, the POS terminal 10A has the same hardware structure as the POS terminal 10.

The CPU 11 of the POS terminal 10A includes a communication control section 114, an information providing section 115, a connection notification section 116 and an informing section 117 as function sections through the execution of the programs stored in the ROM 12 or the storage section 18.

The information providing section 115 provides the peripheral device information relating to the existing peripheral device 20 connected with the self-terminal to the server device 30. Further, no specific limitations are given to the timing when the information providing section 115 provides the peripheral device information to the server device 30. For example, the information providing section 115 may provide the peripheral device information at each predetermined time. Further, if receiving the connection request from the new peripheral device 20, the information providing section 115 may provide the peripheral device information.

No specific limitations are given to the method of providing the peripheral device information. For example, the information providing section 115 may actively send an acquisition request to the server device 30. Further, the information providing section 115 may passively provide the peripheral device information in response to a request from the server device 30.

If the self-terminal receives the connection request of the new peripheral device 20, the connection notification section 116 notifies the server device 30 to receive the connection request from the new peripheral device 20. Herein, the information notified to the server device 30 by the connection notification section 116 contains the terminal identifier of the self-terminal and the type (device type or product type) of the new peripheral device 20 that requests the connection.

The informing section 117 enables the display section 17 to display the informing screen on the basis of informing information sent from the server device 30. For example, the informing section 117 enables the display section 17 to display the informing screens A1-A3 exemplified in FIG. 5-FIG. 7 on the basis of the informing information sent from the server device 30. Further, the informing section 117 may send connection or disconnection and the informing information for urging to switch the connection destination to the new peripheral device 20 that requests the connection on the basis of the informing information sent from the server device 30.

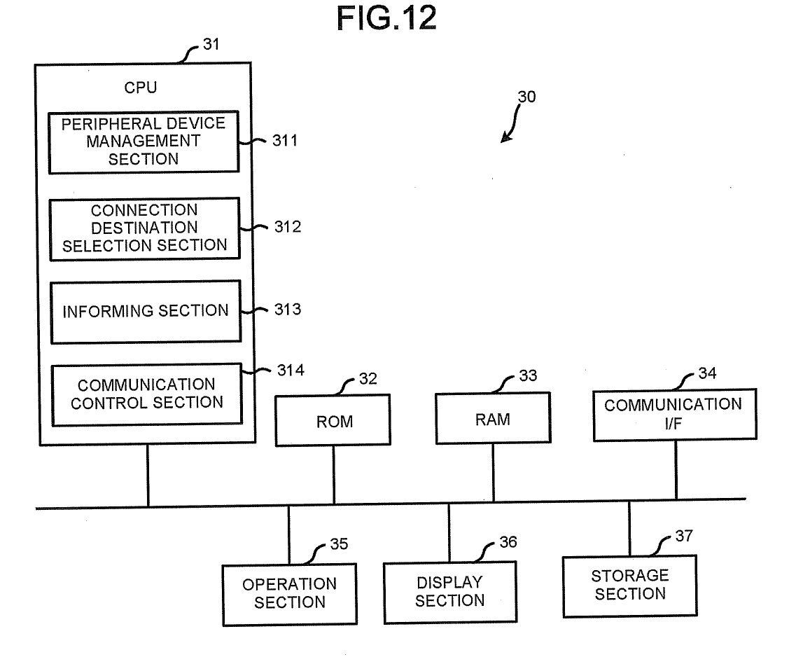

On the other hand, the server device 30 collectively manages the POS terminal 10A and the peripheral device 20, which is an information processing apparatus according to the present embodiment. FIG. 12 is a block diagram illustrating an example of the structure of the server device 30. As shown in FIG. 12, the server device 30 includes a CPU 31, a ROM 32, a RAM 33, a communication I/F 34, an operation section 35, a display section 36 and a storage section 37. Further, the server device 30 includes a timing device such as a RTC (not shown).

The ROM 32 stores various programs executed by the CPU 31 and various kinds of data. The RAM 33 temporarily stores data and programs when the CPU 31 executes various programs. The CPU 31 enables each function section described later to be realized through copying or decompressing various programs stored in the ROM 32 or the storage section 37 on the RAM 33 to execute them.

The communication I/F 34 is, for example, an LAN interface for wired or wireless communication. The server device 30 transmits and receives various kinds of information to and from the POS terminal 10A connected with the network N through the communication I/F 34.

The operation section 35 is an input device such as a keyboard, a pointing device and the like. The operation section 35, if receiving an operation, outputs the operation content to the CPU 31. The display section 36 is a display device such as an LCD (Liquid Crystal Display) and the like. The display section 36 displays various kinds of information under the control of the CPU 31. Further, the display section 36 may be the structure of a touch panel. In this case, the touch panel functions as the operation section 35.

The storage section 37 is a storage device equipped with a non-volatile storage medium such as an HDD (Hard Disk Drive), an SSD (Solid State Drive) and the like. The storage section 37 stores various programs and various kinds of data relating to operations of the server device 30. For example, the storage section 37 stores an information management table. The server device 30 may simultaneously have the function of the store server, and in this case, the storage section 37 stores the commodity master file.

The CPU 31 of the server device 30 includes a peripheral device management section 311, a connection destination selection section 312, an informing section 313 and a communication control section 314 as the function sections through the execution of the programs stored in the ROM 32 or the storage section 37.

The peripheral device management section 311 acquires peripheral device information from each of the POS terminals 10A (information providing section 115). Further, the peripheral device management section 311 stores the acquired peripheral device information in the information management table to manage it. Herein, the information management table managed by the peripheral device management section 311, for example, has the same data structure as the information management tables described in FIG. 3 and FIG. 4.

Further, no specific limitations are given to the timing when the peripheral device management section 311 acquires the peripheral device information from each POS terminal 10A. For example, the peripheral device management section 311 may acquire the peripheral device information at each predetermined time. Further, the peripheral device management section 311 may acquire the peripheral device information in a case in which the connection of the new peripheral device 20 is notified from the POS terminal 10A.

Further, no specific limitations are given to the acquisition method of the peripheral device information. For example, the peripheral device management section 311 may send the acquisition request to each POS terminal 10A to actively acquire the peripheral device information. Further, the peripheral device management section 311 may passively acquire the peripheral device information provided from each of the POS terminals 10A.

The connection destination selection section 312 selects the POS terminal 10A serving as the connection destination candidate of the peripheral device 20 with the use of the information management table. For example, if the receiving of the connection request of a new peripheral device 20 is notified from any one of the POS terminals 10A, the connection destination selection section 312 selects the connection destination candidate of the peripheral device 20 from the POS terminals 10A (terminal identifiers) registered in the information management table. Further, the selection of the connection destination candidate is carried out on the basis of the predetermined selection condition similarly to the first embodiment.

Further, the connection destination selection section 312 selects the connection destination candidate of the existing peripheral device 20 connected with each of the POS terminals 10A according to the selection condition. No limitations are given to the timing when the connection destination selection section 312 selects the connection destination candidate of the existing peripheral device 20. For example, the connection destination selection section 312 may carry out the selection at each predetermined period. Further, the connection destination selection section 312 may carry out the selection at the timing when a new POS terminal 10A is connected.

The informing section 313 informs a selection result of the connection destination selection section 312. For example, in a case in which the connection destination selection section 312 selects some POS terminal 10A as the connection destination candidate of the new peripheral device 20, the informing section 313 displays an informing screen for urging the establishment of the connection with the POS terminal 10A on the display section 36. Further, the informing section 313 sends informing information responding to the selection result of the connection destination selection section 312 to the POS terminal 10A that notifies the receiving of the connection request. In this way, the POS terminal 10A serving as a notification origin enables the display section 17 to display the informing screens shown in FIG. 5-FIG. 7.

The user who operates the new peripheral device 20 or the existing peripheral device 20 confirms the informing screen displayed on the display section 36 of the server device 30 or the display section 17 of the POS terminal 10A that requests the connection. Then, the user carries out an operation for establishing the connection or an operation for switching the connection destination according to the informing screen. In this way, the connection of the POS terminal 10A and the peripheral device 20 is established.

It is assumed that notification destination of the informing section 313 is not limited to the above. For example, the informing section 313 may send the informing information for prompting or urging to receive the connection to the POS terminal 10A selected by the connection destination selection section 312. In this case, in the POS terminal 10A receiving the informing information, the informing section 117 displays the informing screen for prompting or urging to receive the connection with the new peripheral device 20 on the display section 17 according to the informing information.

The communication control section 314 displays a network configuration diagram indicating a connection relationship of the POS terminal 10A and the peripheral device 20 on the display section 36 in response to the specific operation via the operation section 35. Further, the communication control section 314 may automatically control the connection of each POS terminal 10A and the peripheral device 20 similarly to the communication control section 114 described in the first embodiment.

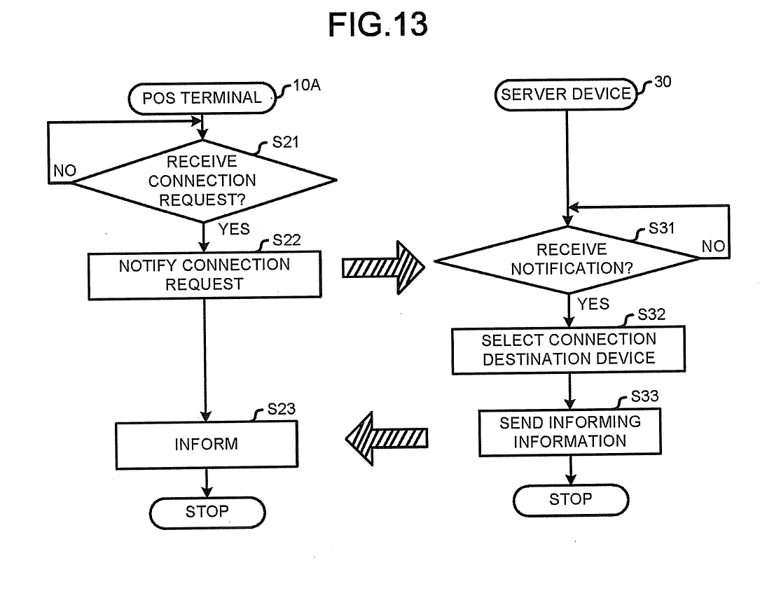

Next, the operations of the POS terminal 10A and the server device 30 are described. FIG. 13 is a flowchart illustrating an example of a connection destination guide processing executed through the cooperation of the POS terminal 10A and the server device 30. The peripheral device information (information management table) is already acquired as a precondition of the present processing.

First, in the POS terminal 10A, the connection notification section 116 waits for the connection request from a new peripheral device 20 (No in Act S21). If receiving the connection request from the new peripheral device 20 (Yes in Act S21), the connection notification section 116 notifies the server device 30 of the receiving of the connection request from the new peripheral device 20 (Act S22).

On the other hand, in the server device 30, the connection destination selection section 312 waits for the notification from the POS terminal 10A (No in Act S31). If receiving information indicating the notification of the receiving of the connection request from any one of the POS terminals 10A (Yes in Act S31), the connection destination selection section 312 selects a POS terminal 10A serving as the connection destination candidate of the peripheral device 20 according to the information management table and the preset selection condition (Act S32). Sequentially, the informing section 313 sends informing information responding to the selection result of the connection destination selection section 312 to the POS terminal 10A serving as the notification origin (Act S33).

If receiving the informing information from the server device 30, the informing section 117 of the POS terminal 10A enables the display section 17 to display the informing screen responding to the informing information to carry out an informing operation (Act S23), and terminates the present processing.

As stated above, according to the server device 30 of the present embodiment, if the new peripheral device 20 requests the connection, the POS terminal 10A serving as the connection destination candidate is selected according to the predetermined selection condition and the selection result is informed. In this way, in a case in which plural connection destinations (POS terminals 10A) of the peripheral device 20 exist, the connection destinations of the peripheral device 20 can be guided to the user. Thus, it can be prevented that a plurality of peripheral devices 20 is concentratedly connected with the specific POS terminal 10. Further, the standardization of the number and the functions of the peripheral devices 20 connected with each POS terminal 10 can be realized.

While certain embodiments are described, these embodiments are presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, in the foregoing embodiment, it is described that the number of the connected peripheral devices and the device type are acquired as the peripheral device information; however, the present invention is not limited to this, and other information relating to the peripheral device 20 may be acquired. For example, information relating to the operation state of the peripheral device 20 or the load of the POS terminal 10 (10A), including bandwidth utilization and the like per unit time, may be acquired as the peripheral device information. In this case, through setting the selection condition aimed at load distribution, the standardization of the load relating to each of the POS terminals 10 (10A) can be realized.

Further, in the foregoing embodiment, it is described that the recommended configuration is set as the selection condition; however, the target of the recommended configuration is not limited to the peripheral device 20 connected wirelessly, and may contain the peripheral device connected in a wired manner (hereinafter, referred to as a wired connection device). For example, in the POS terminal 10 (10A) with the structure shown in FIG. 2, FIG. 11, or FIG. 12, it is possible to connect the wired connection device such as the printer through an input/output I/F (not shown) such as a USB (Universal Serial Bus). Thus, the peripheral device management section 111 (311) acquires the peripheral device information that contains the information relating to the wired connection device and the existing peripheral device 20 from each of the POS terminals 10 (10A). In a case in which the new peripheral device 20 corresponds to the device type set through the recommended configuration, the connection destination selection section 112 (312) selects the POS terminal 10 (10A), with which the determined device types the number of which does not meet the number of the device types set through the recommended configuration are connected, from the information management table. In this way, as the connection destination candidate of the peripheral device 20 can be selected by adding the structure of the wired connection device in the existing peripheral device 20, the convenience can be improved.

The programs executed by each device of the foregoing embodiment may be incorporated into a storage medium (ROM or storage section) of each device to be provided; however, the present invention is not limited to this. The programs may be recorded in a computer-readable recording medium such as a CD-ROM, an FD (Flexible Disk), a CD-R, a DVD (Digital Versatile Disk) and the like in the form of installable or executable file to be provided. Further, the storage medium is not limited to a medium independent from a computer or an embedded system and also contains a storage medium that stores or temporarily stores the programs by downloading the programs transmitted through a LAN or an Internet.

Further, the programs executed by each device of the foregoing embodiment are stored in a computer connected with a network and downloaded via the network to be supplied or may be supplied or distributed via the network such as the Internet.

What is claimed is:

1. An information processing apparatus, comprising:
a management module configured to manage peripheral device information relating to a peripheral device connected with connection destination devices in association with each of the connection destination devices;
a selection module configured to select a connection destination candidate from the connection destination devices on the basis of the peripheral device information if connection is requested from a new peripheral device; and
an informing module configured to inform the connection destination device serving as the connection destination candidate selected by the selection module.

2. The information processing apparatus according to claim 1, wherein
the management module manages the peripheral device information containing the number of the connected peripheral devices; and
the selection module selects the connection destination candidate according to the number of the peripheral devices connected with each of the connection destination devices.

3. The information processing apparatus according to claim 1, further comprising:
a connection control module configured to enable the new peripheral device to be connected to the connection destination device serving as the connection destination candidate selected by the selection module.

4. The information processing apparatus according to claim 2, further comprising:
a connection control module configured to enable the new peripheral device to be connected to the connection destination device serving as the connection destination candidate selected by the selection module.

5. The information processing apparatus according to claim 1, which is one of the connection destination devices, wherein
the selection module selects a connection destination candidate from the connection destination devices containing the information processing apparatus if the connection is request for the information processing apparatus from the new peripheral device.

6. The information processing apparatus according to claim 1, which is a server device for managing each of the connection destination devices, wherein
the selection module selects a connection destination candidate from the connection destination devices if the connection is request for anyone of the connection destination devices from the new peripheral device.

7. A method for guiding a connection destination, including:
managing peripheral device information relating to a peripheral device connected with connection destination devices in association with each of the connection destination devices;
selecting a connection destination candidate from the connection destination devices on the basis of the peripheral device information if connection is requested from a new peripheral device; and
informing the connection destination device serving as the connection destination candidate selected by the selection module.
